(19) United States
(12) Patent Application Publication
(10) Pub. No.: US 2005/0278373 A1
(43) Pub. Date: Dec. 15, 2005

(54) Data retrieval method

(76) Inventors: Steven Corbett, Bristol (GB); Christopher Evans, Bristol (GB); Martin Hogg, Backwell (GB)

Correspondence Address: SWIDLER BERLIN LLP, 3000 K STREET, NW, BOX IP, WASHINGTON, DC, 20007, US

(21) Appl. No.: 10/946,390

(22) Filed: Sep. 22, 2004

(30) Foreign Application Priority Data
Jun. 9, 2004 (GB) 0412883.1

(51) Int. Cl. G06F 7/00

(52) U.S. Cl. 707/102

(57) ABSTRACT

An hierarchical data retrieval method for retrieving an hierarchy of data from a first store is described. The hierarchy of data comprises one or more items of data of a first level, at least one of which is associated with one or more items of data of a second level. The method comprises: i) retrieving from the first store the items of data of the first level only; ii) displaying the items of data of the first level to a user; iii) retrieving from the first store the items of data of the second level associated with one of the items of data of the first level in response to a user request indicating that item of data of the first level; and, iv) displaying the items of data of the second level retrieved in step (iii) in addition to the items of data of the first level.

This invention relates to a method for retrieving hierarchical data.

Hierarchical data is often presented to a user in the form of a tree. Often such trees form part of web pages in which their structure is defined using dynamic hypertext mark up language (DHTML). However, we have found that it can take a significant amount of time to retrieve the data required to construct the tree. Furthermore, this data must be stored locally on the computer which is displaying the web page, and thus the memory requirements of the browser software are large for large trees.

In accordance with one aspect of the present invention, there is provided an hierarchical data retrieval method for retrieving an hierarchy of data from a first store, the hierarchy of data comprising one or more items of data of a first level, at least one of which is associated with one or more items of data of a second level, the method comprising:
i) retrieving from the first store the items of data of the first level only;
ii) displaying the items of data of the first level to a user;
iii) retrieving from the first store the items of data of the second level associated with one of the items of data of the first level in response to a user request indicating that item of data of the first level; and,
iv) displaying the items of data of the second level retrieved in step (iii) in addition to the items of data of the first level.

The invention thus overcomes the problems associated with the prior art by only downloading the items of data as they are required to be displayed to a user. This results in the first level data of the tree being displayed more quickly, and usually reduces the memory requirements of the browser software as it is not necessary to load all the hierarchical data unless the user specifically requests to see all the data.

Normally, the items of data retrieved in steps (i) and (iii) are stored in a second store, and typically this second store is a solid state memory device.

In a preferred embodiment, the method further comprises discarding from the second store the items of data from the second level associated with one of the items of data from the first level in response to a user request indicating that item of data of the first level. However, it is not essential to discard the items of data from the second level. Instead, they may simply be hidden from the user, but retained in the second store, in response to the user request indicating the associated item of data of the first level.

Typically, the first store is situated on a remote server, and the first store may be a database.

Normally, the data retrieved in steps (i) and (iii) are retrieved via a network, such as the Internet.

In one embodiment, the method further comprises comparing, in response to a user command, any items of data retrieved in steps (i) and (iii) with corresponding items in the first store to determine if the items in the first store have been updated since the items of data of steps (i) and (iii) were retrieved, and if there are any differences, retrieving the corresponding items from the first store and replacing the items of data of steps (i) and (iii) with these.

In accordance with a second aspect of the present invention, a computer program comprises computer program code means adapted to perform the steps of the first aspect of the invention when said program is run on a computer.

In accordance with a third aspect of the present invention, a computer program product comprises computer program code means adapted to perform the steps of any of claims 1-9 when said program is run on a computer.

An embodiment of the invention will now be described with reference to the accompanying drawings, in which:—

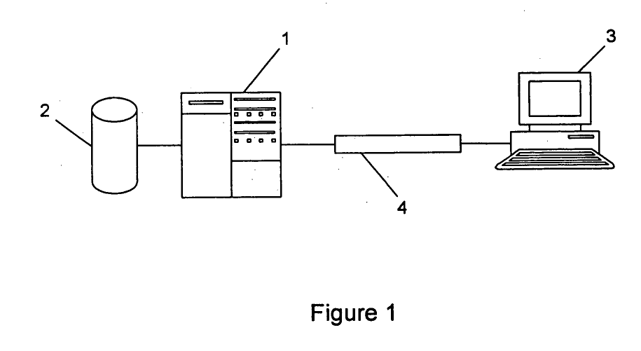

FIG. 1 shows a computer system adapted to perform the invention;

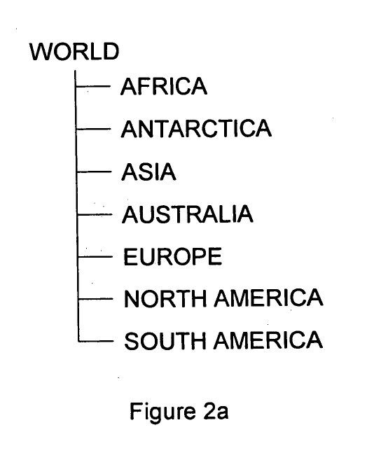

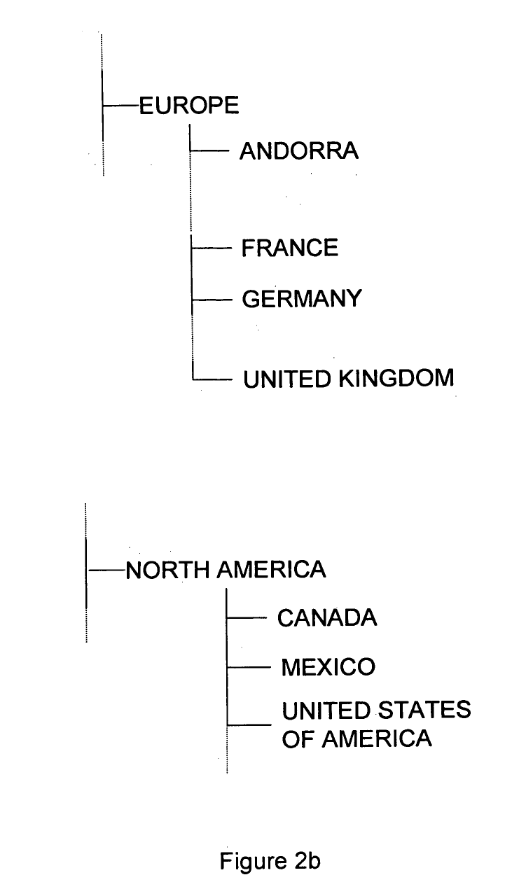

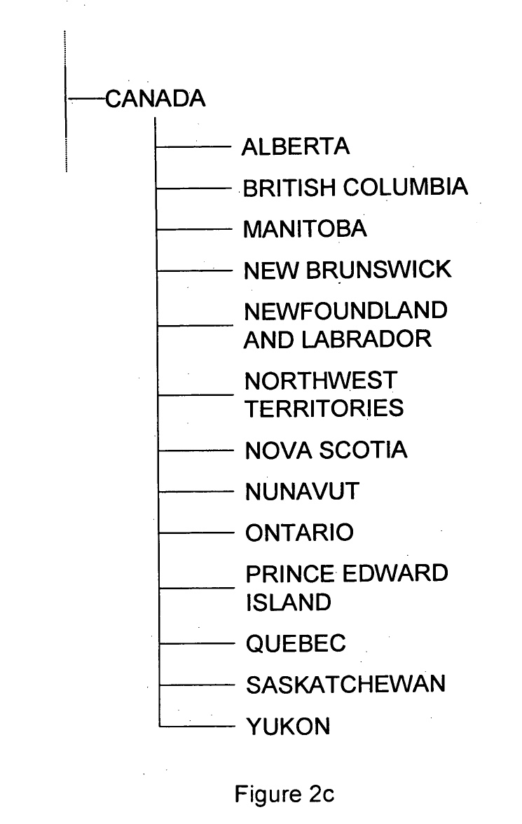

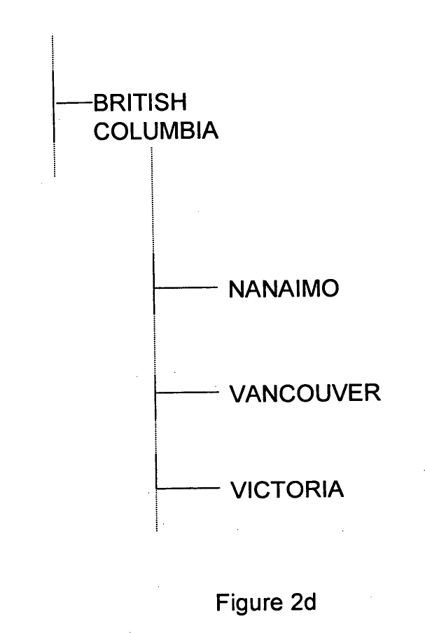

FIGS. 2a-2d show examples of hierarchical data;

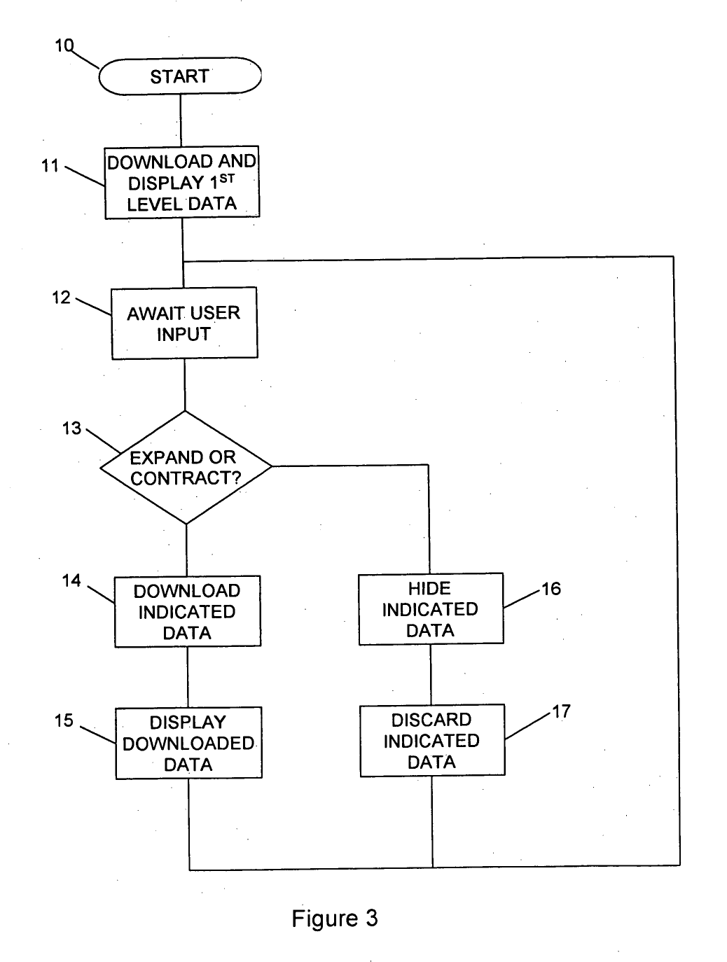

FIG. 3 shows a flow diagram of one embodiment of the method; and

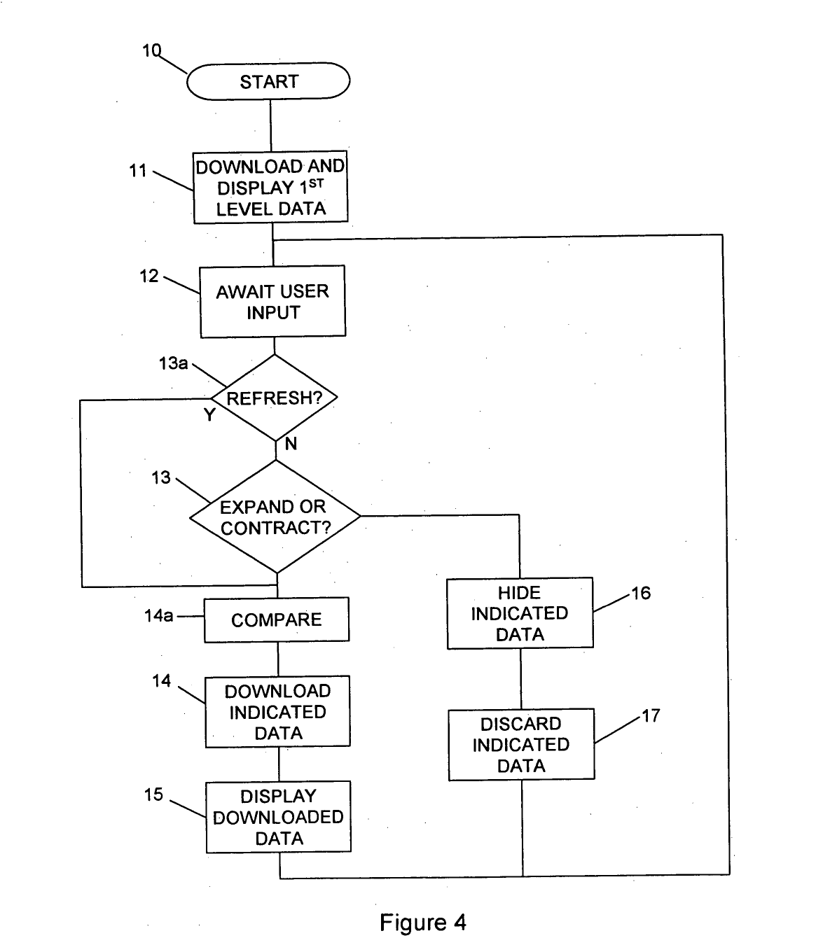

FIG. 4 shows a flow diagram of a second embodiment.

FIG. 1 shows a system adapted to perform the present invention. In this system, there is a server 1 connected to a database 2, and to a client 3 via the Internet 4.

The database 2 stores a set of hierarchical data that are shown in FIGS. 2a-2d. The first level of the hierarchical data are shown in FIG. 2a, and it can be seen that these represent the seven continents of the world. FIG. 2b shows the second level of data associated with the continents of Europe and North America. These second level data represent the countries that constitute the respective continents (although not all countries are shown for the sake of brevity). FIG. 2c shows a third level of the hierarchical data, which in this instance represents the provinces of Canada. FIG. 2d shows a fourth level of the hierarchical data which are associated with the province of British Columbia, and represent the cities of British Columbia (again, not all are shown for the sake of brevity).

The operation of the invention will now be described with reference to FIG. 3. This shows a flow diagram which proceeds from a start stage 10 directly to download the first level hierarchical data in stage 11. These data are downloaded to the client 3 from server 1 via the Internet 4 as a result of a request to access a web page that is stored on the database 2 connected to server 1. Server 1 in response to this request retrieves data from the database 2 including the first level data and transmits these to the client 3 via the Internet 4. The data are then stored in a memory in the client 3, and displayed.

The process then proceeds in step 12 to await user input. In this example, the user may be interested in seeing the second level data associated with the continent of Europe and he may provide the necessary user input for stage 12 by selecting the continent of Europe from the displayed first level data, thereby indicating that he wishes to expand the tree to show the countries of Europe.

The user input is detected by a decision stage 13 and this determines that the lower level data associated with the data item (i.e. Europe) selected by the user has not yet been downloaded. As a result, processing proceeds to stage 14. In stage 14, the data representing the countries of Europe, as shown in FIG. 2b, are downloaded by issuing a request from client 3 to server 1 to retrieve these data from database 2. These data are downloaded from the server 1, stored in the memory in client 3, and then displayed to the user in stage 15.

Processing then proceeds from stage 15 to stage 12 where further user input is awaited. At this stage, the user may indicate that he wishes to retrieve further second level data relating to the continent of North America which is displayed in the first level of hierarchical data shown in FIG. 2a. Retrieval of this data from the database 2 proceeds in the same manner as previously described with respect to that data for Europe and the second level data representing the constituent countries of North America, as shown in FIG. 2b, are downloaded in stage 14, stored in the memory, and then displayed to the user in step 15. Processing then reverts to stage 12.

The user may then decide that he wishes to retrieve third level hierarchical data associated with the country of Canada. In response to this user input, decision stage 13 determines, in the same way as before, that it is desired to expand the tree, and processing proceeds to stage 14 where the third level data associated with the second level data item of Canada is retrieved from the database 2 connected to server 1 via the Internet 4, and stored in the memory in client 3. The retrieved third level data, shown in FIG. 2c, is then displayed to the user along with the second and first level data in stage 15.

It should be apparent that the hierarchical data may contain an extremely large number of levels, each level being associated with a data item of a higher level. FIG. 2d shows fourth level data related to the Canadian province of British Columbia which represent the cities of British Columbia and these may be downloaded and displayed to the user as already described. Obviously, further levels of data may also be incorporated in the hierarchical data structure although none is shown in this example. For example, a fifth level may represent the districts of the cities represented by the fourth level data, and a sixth level of data may represent the streets within each district represented by the fifth level data.

Having displayed all this data to the user, it may be that the user requires to contract the levels and he may indicate this by selecting one of the already expanded items, for example the province of British Columbia in FIG. 2d.

In this case, decision stage 13 determines that the lower level data associated with the selected data item (i.e. British Columbia) have already been downloaded. As a result, decision stage 13 passes control to stage 16 which hides the fourth level data of FIG. 2d from the user. These fourth level data are then discarded in stage 17 from the memory in client 3 in which they are stored. Processing reverts then to stage 12, as before.

In fact, stage 17 is optional since it is not essential to discard the hidden data. Instead, they may be retained in the memory in client 3 in case they are required again by the user. In this case, they are simply hidden in stage 16 from which processing proceeds to stage 12, as before.

It will be apparent from the foregoing discussion that initially only the first level data is downloaded and displayed on the client 3 and that subsequent levels of the hierarchical data are only downloaded on request, and then may be discarded when no longer required. As such, the download of hierarchical data may be made very much quicker, and the memory requirements are significantly lower.

FIG. 4 shows a second embodiment of the invention. This is similar to that previously described with reference to FIGS. 1 to 3, but includes the additional feature of automatically downloading items of the hierarchical data that have been changed in the database 2 since they were downloaded by client 3. Such data on the database 2 may have been changed by the actions of another user, or indeed by an automated process.

The embodiment of FIG. 4 varies from that of FIG. 3 in that an additional decision stage 13a, and a new processing stage 14a are incorporated. Furthermore, the processing stage 14 is modified as will be described below.

In this embodiment, processing in stages 10 to 12 is identical to that of the embodiment of FIG. 3, but processing proceeds from stage 12 to decision stage 13a which determines whether a user has issued a refresh command. If the user has issued a refresh command then processing proceeds to stage 14a which compares the hierarchical data already downloaded with that stored on the database 2. If there are any differences then replacement data is downloaded in stage 14 and displayed to the user in stage 15 in place of the erroneous data. Processing then reverts to stage 12.

As an alternative, if the user issues a refresh command, instead of proceeding to the comparison stage 14a, the client 3 may simply issue a request to the server 1 to replace all the data that has previously been downloaded with new versions.

If the user has not issued a refresh command then processing proceeds from decision stage 13a to decision stage 13. If the user has issued a request for further data (i.e. to expand the tree) then processing proceeds from stage 13 to stage 14a. As previously described, stage 14a compares the previously downloaded hierarchical data with those stored on database 2. If there are any differences between these then replacement data are downloaded in stage 14 along with any new data indicated by the user. The replacement and indicated data are displayed in stage 15 before processing reverts to stage 12.

The processing stages 16 and 17 are executed if the user indicates that he wishes to contract the tree, and are identical with those already described with reference to FIG. 3.

It is important to note that while the present invention has been described in a context of a fully functioning data processing system, those of ordinary skill in the art will appreciate that the processes of the present invention are capable of being distributed in the form of a computer readable medium of instructions and a variety of forms and that the present invention applies equally regardless of a particular type of signal bearing media actually used to carry out distribution. Examples of computer readable media include recordable-type media such as floppy disks, a hard disk drive, RAM and CD-ROMs as well as transmission-type media such as digital and analogue communications links.

1. An hierarchical data retrieval method for retrieving an hierarchy of data from a first store, the hierarchy of data comprising one or more items of data of a first level, at least one of which is associated with one or more items of data of a second level, the method comprising:
i) retrieving from the first store the items of data of the first level only;
ii) displaying the items of data of the first level to a user;
iii) retrieving from the first store the items of data of the second level associated with one of the items of data of the first level in response to a user request indicating that item of data of the first level; and,
iv) displaying the items of data of the second level retrieved in step (iii) in addition to the items of data of the first level.

2. An hierarchical data retrieval method according to claim 1, wherein the items of data retrieved in steps (i) and (iii) are stored in a second store.

3. An hierarchical data retrieval method according to claim 2, wherein the second store is a solid state memory device.

4. An hierarchical data retrieval method according to claim 2, the method further comprising discarding from the second store the items of data of the second level associated with one of the items of data of the first level in response to a user request indicating that item of data of the first level.

5. An hierarchical data retrieval method according to claim 3, the method further comprising discarding from the second store the items of data of the second level associated with one of the items of data of the first level in response to a user request indicating that item of data of the first level.

6. An hierarchical data retrieval method according to claim 1, wherein the first store is situated on a remote server.

7. An hierarchical data retrieval method according to claim 1, wherein the first store is a database.

8. An hierarchical data retrieval method according to claim 1, wherein the data retrieved in steps (i) and (iii) are retrieved via a network.

9. An hierarchical data retrieval method according to claim 8, wherein the network is the Internet.

10. An hierarchical data retrieval method according to claim 1, further comprising comparing, in response to a user command, any items of data retrieved in steps (i) and (iii) with corresponding items in the first store to determine if the items in the first store have been updated since the items of data of steps (i) and (iii) were retrieved, and if there are any differences, retrieving the corresponding items from the first store and replacing the items of data of steps (i) and (iii) with these.

11. A computer program comprising computer program code means adapted to perform the steps of claim 1 when said program is run on a computer.

12. A computer program product comprising computer program code means adapted to perform the steps of claim 1 when said program is run on a computer.
